(19) United States
(12) Patent Application Publication
(10) Pub. No.: US 2008/0311406 A1
(43) Pub. Date: Dec. 18, 2008

(54) (Ligno) Cellulose Material Board Coated with a Pmma and Pvdf-Based film

(75) Inventors: Anthony Bonnet, Beaumont Le Roger (FR); Johann Laffargue, Bernay (FR); Nadine Rivas, La Londe (FR); Karine Triballier, Bosrobert (FR); Sandrine Duc, Istres (FR); Cyrille Mathieu, Rouen (FR); Frederic Godefroy, Mesnil Sous Jumieges (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 12/096,089

(22) PCT Filed: Dec. 6, 2006
(86) PCT No.: PCT/FR2006/051291

§ 371 Date: Aug. 22, 2008

(30) Foreign Application Priority Data
Dec. 6, 2005 (FR) 0512336

(51) Int. Cl. B32B 27/08

(52) U.S. Cl. 428/421

(57) ABSTRACT

The invention relates to the use of a coextruded multilayer film for protecting a (lingo)cellulose material, wherein said multilayer film consists of the following arranged to each other layers: a surface layer (I) comprising PVDF and possibly PMMA in the form of the main components, an intermediate layer (II) comprising in the form of main components 0-60 PVDF parts, 40 to 100 PMMA parts, 0-25 acrylic elastomer parts, and 0-10 UV absorber parts, the totality thereof being equal to 100 parts, and an adhesive layer (III), which comprises a functional PMMA in the form of the main component and is arranged on the side of the (ligno)cellulose material.

This application claims benefit, under U.S.C. §119 or §365 of French Application Number FR05.12336, filed Dec. 6, 2005; and PCT/FR2006/051291 filed Dec. 6, 2006.

The invention relates to the use of a multilayer film based on PMMA and PVDF for protecting a (ligno)cellulose material or a panel made of (ligno)cellulose material. The invention also relates to this panel. This type of panel is widely used in everyday life, in particular in the exterior cladding of facades. It is generally a sandwich panel.

### THE TECHNICAL PROBLEM

Panels made of (ligno)cellulose material of sandwich panel type are panels used in the cladding of exterior or interior facades or else in producing floors. In order to provide stability of colour and of appearance, it is necessary to protect these panels against UV radiation, chemicals, scratches, atmospheric agents (dampness, salt spray, and the like), fungi and moulds, or graffiti. It is known to use a plastic film which will cover and protect one of the faces of the panel.

In order to ensure optimum protection, it is necessary for the film to adhere perfectly to the panel and for the adhesion to be maintained over time. Furthermore, in the case where the panel is in contact with a damp atmosphere (rain, salt spray, and the like), it is necessary for the contact with the moisture not to result in whitening the film. Neither should detachment occur under the conditions of the test, which consist in immersing a board covered with a film in boiling water for 2 hours.

The Applicant Company has developed a multilayer film which adheres perfectly to the panel without whitening on contact with moisture and which provides such protection.

### THE PRIOR ART

European Application EP 1 405 872 A1 discloses a multilayer film based on PVDF and PMMA for covering objects made of thermoset material. The adhesive layer of the film in contact with the object to be covered comprises a functional PMMA.

Applications EP 1 382 640 A1 and EP 1 566 408 A1 disclose a multilayer film in which the adhesive composition in contact with the object to be covered comprises a blend of PVDF and PMMA. The PMMA can be functional.

European Application EP 1 199 157 A1 discloses a laminated panel coated with a transparent/translucent multilayer film of acrylic nature on at least one of its faces. No mention is made of the film of the invention nor even less of functional PMMA.

European Application EP 1 388 414 A1 discloses a laminated panel coated with a PMMA/PVDF two-layer film or a monolayer film based on a PMMA/PVDF blend. No mention is made of the film of the invention nor even less of functional PMMA.

U.S. Pat. No. 5,232,164 discloses a multilayer film comprising a surface layer and a layer which comes into contact with the substrate based on a PMMA which can be functional.

Application US 2003/0180564 A1 discloses a multilayer film which can be used to protect plastic, metal or wood. The multilayer film comprises, in order, a PMMA layer, a decorative layer and a PVDF layer. Mention is not made of a functional PMMA layer.

### BRIEF DESCRIPTION OF THE INVENTION

The invention relates to the use of a coextruded multilayer film for protecting a (ligno)cellulose material, the multilayer film comprising, in order, positioned one against another:
a surface layer (I) comprising, as main constituents, a PVDF and optionally a PMMA;
an intermediate layer (II) comprising, as main constituents, from 0 to 60 parts of a PVDF, from 40 to 100 parts of a PMMA, from 0 to 25 parts of an acrylic elastomer and from 0 to 10 parts of a UV absorber, the total forming 100 parts;
an adhesive layer (III) comprising, as main constituent, a functional PMMA,
   the adhesive layer (III) being positioned on the side of the (ligno)cellulose material.

The invention also relates to the use of the multilayer film for protecting a panel comprising at least one layer of a (ligno)cellulose material, the film being applied on at least one of the two outer faces of the panel composed of a (ligno)cellulose material, the adhesive layer (III) being positioned on the side of at least one of the said outer faces of the panel.

The invention also relates to a multilayer structure comprising at least one layer of a (ligno)cellulose material and the multilayer film positioned against this layer, the adhesive layer (III) being positioned on the side of the (ligno)cellulose material. The invention also relates to a panel comprising at least one layer of a (ligno)cellulose material for which at least one of the two outer faces, composed of a (ligno)cellulose material, of the panel is protected by the multilayer film, the adhesive layer (III) being positioned on the side of at least one of the said outer faces of the panel.

Prior French Application FR 05.12336, the priority of which is claimed, is incorporated here in its entirety by reference.

### DETAILED DESCRIPTION OF THE INVENTION

### Preliminary Definitions

(Meth)acrylate denotes both an acrylate and a methacrylate. (Meth)acrylic acid denotes both acrylic acid and methacrylic acid. (Ligno)cellulose denotes both cellulose and lignocellulose.

PVDF denotes a VDF (vinylidene fluoride, CH₂═CF₂) homopolymer or a VDF copolymer comprising preferably at least 50% by weight of VDF and at least one other monomer which can be copolymerized with VDF. Preferably, the PVDF comprises, by weight, at least 75%, preferably at least 85%, of VDF.

Advantageously, the comonomer is fluorinated. It can be chosen, for example, from vinyl fluoride; trifluoroethylene (VF3); chlorotrifluoroethylene (CTFE); 1,2-difluoroethylene; tetrafluoroethylene (TFE); hexafluoropropylene (HFP); perfluoro(alkyl vinyl)ethers, such as perfluoro(methyl vinyl)ether (PMVE), perfluoro(ethyl vinyl)ether (PEVE) and perfluoro(propyl vinyl)ether (PPVE); perfluoro(1,3-dioxole); or perfluoro(2,2-dimethyl-1,3-dioxole) (PDD).

Preferably, the optional comonomer is chosen from chlorotrifluoroethylene (CTFE), hexafluoropropylene (HFP), trifluoroethylene (VF3) and tetrafluoroethylene (TFE). Very preferably, it is HFP.

Advantageously, the PVDF has a viscosity ranging from 100 Pa·s to 2000 Pa·s, the viscosity being measured at 230° C. at a shear rate gradient of 100 s⁻¹ using a capillary rheometer. This is because these PVDFs are well suited to extrusion and to injection moulding. Preferably, the PVDF has a viscosity ranging from 300 Pa·s to 1200 Pa·s, the viscosity being measured at 230° C. at a shear rate gradient of 100 s⁻¹ using a capillary rheometer.

PMMA denotes a homopolymer of methyl methacrylate (MMA) or a copolymer comprising, by weight, at least 50% by weight of MMA and at least one comonomer which can be copolymerized with MMA. Preferably, the PMMA comprises, by weight, at least 70% of MMA.

Mention may be made, as examples of comonomer, for example, of alkyl(meth)acrylates, more particularly those having an alkyl group comprising from 2 to 4 carbon atoms, acrylonitrile or vinylaromatic monomers, such as styrene. Examples of alkyl(meth)acrylates are described in Kirk-Othmer, Encyclopedia of Chemical Technology, 4th edition, in Vol. 1, pages 292-293, and in Vol. 16, pages 475-478. Advantageously, the PMMA can comprise 0 to 30% by weight and preferably 5 to 30% of a C₂-C₄ alkyl(meth)acrylate, preferably methyl acrylate and/or ethyl acrylate.

Functional PMMA denotes a PMMA which comprises acid, acid salt, acid chloride, epoxide, alcohol or anhydride functional groups. These functional groups can be introduced by grafting or by copolymerization of at least one monomer carrying at least one acid, acid salt, acid chloride, epoxide, alcohol or anhydride functional group.

The functional PMMA can comprise, by weight, from 0.5 to 15%, advantageously from 1 to 10%, preferably from 2 to 10%, of at least one monomer carrying at least one acid, acid salt, acid chloride, epoxide, alcohol or anhydride functional group. The copolymerization can be carried out according to a bulk process, solution in a solvent process, emulsion process or suspension process. The grafting is carried out in solution in a solvent or else in the molten state in a suitable mixing device, such as, for example, an extruder.

Mention may be made, as examples of monomer carrying an epoxy-functional group, of allyl glycidyl ether, vinyl glycidyl ether, glycidyl maleate, glycidyl itaconate, glycidyl acrylate and glycidyl methacrylate. Glycidyl methacrylate is a preferred monomer as it copolymerizes efficiently with MMA.

Mention may be made, as examples of monomer carrying an acid functional group, of 2-acrylamido-2-methylpropane-sulphonic acid, vinylsulphonic acid, styrenesulphonic acid, 1-allyloxy-2-hydroxypropanesulphonic acid, alkyl allyl sulphosuccinic acid, acrylic acid, methacrylic acid, crotonic acid, itaconic acid, fumaric acid or maleic acid. It is preferably acrylic acid or methacrylic acid as these two monomers copolymerize very well with MMA. Methacrylic acid is very particularly preferred when the copolymerization is carried out in aqueous disperse medium as acrylic acid has a tendency to remain largely dissolved in the water, which is not the case with methacrylic acid.

Mention may be made, as examples of monomer carrying an anhydride functional group, of maleic anhydride, itaconic anhydride or citraconic anhydride. The anhydride functional group can also be introduced by reaction of two neighbouring acid functional groups.

To obtain a functional PMMA carrying glutaric anhydride groups, use may be made of one of the methods disclosed in the documents EP 0 318 197 B1, Japanese Kokai 60/231,756, Japanese Kokai 61/254608 or Japanese Kokai 61/43604, GB 1 437 176 or U.S. Pat. No. 4,789,709. According to the method described in EP 0 318 197, the PMMA is reacted with a secondary amine. The reaction is carried out at a temperature of greater than 150° C., preferably between 200 and 280° C., optionally in the presence of a reduced pressure of less than 1 bar and optionally in the presence of an acidic or basic catalyst. This reaction can be carried out in an extruder equipped with a venting well or else in a devolatilizer.

Use is preferably made of a functional PMMA obtained by the copolymerization of MMA, (meth)acrylic acid and optionally a 3rd monomer which can be copolymerized with MMA. The 3rd comonomer is chosen from the list of the PMMA comonomers defined above. Two neighbouring (meth)acrylic acid functional groups can dehydrate to form an anhydride functional group. The dehydration can, for example, be carried out in the devolatilization and/or extrusion stages which follow the copolymerization stage. This functional PMMA comprises, by weight:
from 65 to 99.5% of MMA,
from 0.5 to 15% of (meth)acrylic acid and/or the anhydride resulting from (meth)acrylic acid,
from 0 to 20% of the 3rd monomer which can be copolymerized with the MMA.

Advantageously, it comprises, by weight:
from 70 to 99% of MMA,
from 1 to 10% of (meth)acrylic acid and/or the anhydride resulting from (meth)acrylic acid,
from 0 to 20% of the 3rd monomer which can be copolymerized with the MMA.

Preferably, it comprises, by weight:
from 70 to 98% of MMA,
from 2 to 10% of (meth)acrylic acid and/or the anhydride resulting from (meth)acrylic acid,
from 0 to 20% of the 3rd monomer which can be copolymerized with the MMA.

The MVI (melt volume index) of the PMMA can be between 2 and 15 cm³/10 min, measured at 230° C. under a load of 3.8 kg.

One example of functional PMMA is the Altuglas® HT121 grade sold by Altuglas International. This product includes approximately 4.5% by weight of methacrylic acid or anhydride resulting from methacrylic acid. It exhibits a melt index of 2 g/10 min (230° C., 3.8 kg).

Acrylic elastomer denotes an elastomer based on at least one monomer chosen from acrylonitrile, alkyl (meth)acrylates and multilayer particles of core-shell type.

As regards the particles of core-shell type, these are provided in the form of fine multilayer particles having at least one elastomeric layer (that is to say, “soft”) and at least one thermoplastic layer (that is to say, “hard”). The size of the particles is generally less than one μm and advantageously between 50 and 300 nm.

Mention may be made, as examples of elastomeric layer, of homopolymers of isoprene or butadiene, copolymers of isoprene with at most 30 mol % of a vinyl monomer and copolymers of butadiene with at most 30 mol % of a vinyl monomer. The vinyl monomer can be styrene, an alkylstyrene, acrylonitrile or an alkyl(meth)acrylate. Another elastomeric layer family is composed of homopolymers of an alkyl(meth)acrylate and copolymers of an alkyl (meth)acrylate with at most 30 mol % of a monomer chosen from another alkyl(meth)acrylate and a vinyl monomer. The alkyl(meth)acrylate is advantageously butyl acrylate. The vinyl monomer can be styrene, an alkylstyrene, acrylonitrile, butadiene or isoprene.

The thermoplastic layer can be a homopolymer of styrene, an alkylstyrene or methyl methacrylate or a copolymer comprising at least 70 mol % of one of these preceding monomers and at least one comonomer chosen from the other preceding monomers, another alkyl(meth)acrylate, vinyl acetate and acrylonitrile.

Each of these layers can be crosslinked in all or part. It is sufficient to add at least one at least difunctional monomer during the preparation of the layer, it being possible for this monomer to be chosen from poly(meth)acrylic esters of polyols, such as butylene di(meth)acrylate and trimethylolpropane trimethacrylate. Other difunctional monomers are, for example, divinylbenzene, trivinylbenzene, vinyl acrylate and vinyl methacrylate. It is also possible to crosslink by introducing an unsaturated functional monomer, such as an unsaturated carboxylic acid anhydride, an unsaturated carboxylic acid or an unsaturated epoxide. Mention may be made, by way of examples, of maleic anhydride, (meth)acrylic acid and glycidyl methacrylate.

Mention may be made, as examples of multilayer particles of core-shell type, of those referred to as soft/hard having an elastomeric inner layer (core) and a thermoplastic outer layer (shell). There also exists particles having two thermoplastic layers, one made of polystyrene and the other, on the outside, made of PMMA. Advantageously, the core represents, by weight, 70 to 90% of the particle and the shell 30 to 10%. Mention may be made, as example of soft/hard particles, of those composed: (i) of 75 to 80 parts of a core comprising, in moles, at least 93% of butadiene, 5% of styrene and 0.5 to 1% of divinylbenzene and (ii) of 25 to 20 parts of two shells essentially of the same weight, the inner one made of polystyrene and the outer one made of PMMA. Mention may be made, as another example of soft/hard particles, of those having a core made of poly(butyl acrylate) or of copolymer of butyl acrylate and butadiene and a shell made of PMMA. Mention may also be made of those composed, in order: (i) of a soft core (40% by weight) obtained by polymerizing 99 parts of butyl acrylate and 1 part of allyl methacrylate and (ii) of a hard shell (60% by weight) obtained by polymerizing 95 parts of MMA and 5 parts of butyl acrylate in the presence of 0.002 part of n-dodecyl mercaptan. European Application EP 1 061 100 A1 discloses such particles.

There also exists other types of particles of core-shell type referred to as hard/soft/hard having, in order, a thermoplastic core, an elastomeric intermediate layer and a hard shell. Application US 2004/0030046 A1 discloses examples of such particles. Mention may be made, for example, of those composed, in order: (i) of a hard core made of copolymer of methyl methacrylate and ethyl acrylate, (ii) of an intermediate layer made of copolymer of butyl acrylate and styrene and (iii) of a hard shell made of copolymer of methyl methacrylate and ethyl acrylate. Mention may also be made of those composed, in order: (i) of a hard core (23% by weight) obtained by polymerizing 92.7 parts of MMA, 10 parts of ethyl acrylate and 0.3 part of allyl methacrylate, (ii) of a soft intermediate layer (47% by weight) obtained by polymerizing 81.7 parts of butyl acrylate, 17 parts of styrene and 1.3 parts of allyl methacrylate and (iii) of a hard shell (30% by weight) obtained by polymerizing 96 parts of MMA and 4 parts of ethyl acrylate.

There also exists other types of particles of core-shell type referred to as hard/soft/semi-hard. In comparison with the preceding particles, the difference results from the “semi-hard” outer shell, which is composed of two shells: the intermediate one and the other outer one. The intermediate shell is a copolymer of methyl methacrylate, styrene and at least one monomer chosen from alkyl acrylates, butadiene and isoprene. The outer shell is a PMMA homopolymer or copolymer. Mention may be made, for example, of those composed, in this order: (i) of a core made of copolymer of methyl methacrylate and ethyl acrylate, (ii) of an intermediate layer made of copolymer of butyl acrylate and styrene (iii) of a 1st shell made of copolymer of methyl methacrylate, butyl acrylate and styrene and (iv) of a 2nd shell made of copolymer of methyl methacrylate and ethyl acrylate.

On choosing the proportions of acrylic elastomer, it is necessary to take into account that which may already be present in the PMMA. This is because there exists commercial grades of PMMA, referred to as “impact grade”, which comprise acrylic impact modifiers generally of core-shell type. These acrylic impact modifiers may be present in the PMMA because they were introduced during its polymerization or were prepared simultaneously during its polymerization.

Examples of particles and their processes of preparation are disclosed in the following patents: U.S. Pat. No. 4,180,494, U.S. Pat. No. 3,808,180, U.S. Pat. No. 4,096,202, U.S. Pat. No. 4,260,693, U.S. Pat. No. 3,287,443, U.S. Pat. No. 3,657,391, U.S. Pat. No. 4,299,928, U.S. Pat. No. 3,985,704 and U.S. Pat. No. 5,773,520. The particles of core-shell type which can be used are, for example, IRH 70 from Mitsubishi (soft/hard two layer with a soft core made of butadiene/butyl acrylate copolymer and a hard shell made of PMMA) or KM-355 from Röhm and Haas.

As regards the multilayer film, the latter is a coextruded multilayer film comprising, in order, positioned one against another:
a surface layer (I) comprising, as main constituents, a PVDF and optionally a PMMA;
an intermediate layer (II) comprising, as main constituents, from 0 to 60 parts of a PVDF, from 40 to 100 parts of a PMMA, from 0 to 25 parts of an acrylic elastomer and from 0 to 10 parts of a UV absorber, the total forming 100 parts;
an adhesive layer (III) comprising, as main constituent, a functional PMMA.

The main role of the surface layer (I) is to protect the substrate. The main role of the intermediate layer (II) is to provide the film with flexibility (for example, during the manufacture thereof and the handling thereof) and also, when the layer comprises a UV absorber, to strengthen the UV protection. The main role of the adhesive layer (III) is to provide adhesion to the substrate and to prevent the film from delaminating.

The multilayer film can be prepared by coextrusion. The coextrusion technique is based on the use of as many extruders as there are layers to be extruded, the sheets of molten material resulting from each of the extruders being subsequently combined together to form the multilayer film (for further details, reference may be made to the work Principles of Polymer Processing by Z. Tadmor, published by Wiley, 1979). The mixtures of the ingredients forming each of the layers are obtained in each of the extruders used for the coextrusion or else beforehand in separate extruders. Use may be made, as in the examples, of the blown film technique.

The thickness of the surface layer (I) is advantageously between 1 and 100 μm, preferably between 2 and 40 μm. The thickness of the intermediate layer (II) is advantageously between 1 and 100 μm, preferably between 10 and 60 μm. The thickness of the adhesive layer (III) is advantageously between 1 and 100 μm, preferably between 2 and 40 μm. The film with the advantageous thicknesses described exhibits the mechanical properties sufficient to allow it to be handled, processed and used.

As regards the surface layer (I), the latter comprises, as main constituents, a PVDF and optionally a PMMA. Preferably, the surface layer (I) comprises, as main constituents, from 50 to 100 parts of PVDF per respectively from 50 to 0 parts of PMMA, the total forming 100 parts. Advantageously, the surface layer (I) comprises, as main constituents, from 70 to 100 parts of PVDF per respectively from 30 to 0 parts of PMMA and preferably from 75 to 85 parts of PVDF per respectively 25 to 15 parts of PMMA, the total forming 100 parts.

According to one alternative form, the surface layer (I) exists in the form of two superimposed layers:
a layer (Ia) comprising, as main constituents, 75 to 100 parts of PVDF per respectively 25 to 0 parts of PMMA;
a layer (Ib) comprising, as main constituents, 50 to 90 parts of PVDF per respectively 50 to 10 parts of PMMA.

The layer (Ib) is the layer in contact with the intermediate layer (II) and the layer (Ia) is the “outer” layer, that is to say that the multilayer film comprises, in order, the layers (Ia)/(Ib)/(II)/(III).

As regards the intermediate layer (II), the latter comprises, as main constituents, from 0 to 60 parts of PVDF, from 40 to 100 parts of PMMA, from 0 to 25 parts of acrylic elastomer and from 0 to 10 parts of UV absorber, the total forming 100 parts. Advantageously, it comprises from 20 to 60 parts of PVDF, from 40 to 60 parts of PMMA, from 0 to 25 parts of acrylic elastomer and from 0 to 10 parts of UV absorber, the total forming 100 parts. Advantageously, it comprises from 30 to 50 parts of PVDF, from 40 to 60 parts of PMMA, from 0 to 20 parts of an acrylic elastomer and from 0 to 5 parts of a UV absorber, the total forming 100 parts.

In order to guarantee that the film does not whiten, even under the conditions of the test with boiling water, the intermediate layer does not comprise any acrylic elastomer. It comprises from 20 to 50 parts of PVDF, from 50 to 80 parts of a PMMA comprising, by weight, from 90 to 50% of MMA per respectively from 10 to 50% of an alkyl (meth)acrylate, the alkyl having from 2 to 4 carbon atoms, and from 0 to 5 parts of a UV absorber, the total forming 100 parts.

More preferably still, it comprises, by weight, from 25 to 45 parts of PVDF, from 55 to 75 parts of PMMA comprising, by weight, from 90 to 50% of MMA per respectively from 10 to 50% of an alkyl(meth)acrylate, the alkyl having from 2 to 4 carbon atoms, and from 0 to 5 parts of a UV absorber, the total forming 100 parts. Preferably, the PMMA comprises, by weight, from 85 to 70% of MMA per respectively from 15 to 30% of an alkyl(meth)acrylate, the alkyl having from 2 to 4 carbon atoms.

Preferably, the PMMA comprises, by weight, from 80 to 70% of MMA per respectively from 20 to 30% of an alkyl (meth)acrylate, the alkyl having from 2 to 4 carbon atoms. Use is advantageously made, as alkyl(meth)acrylate, of methyl acrylate, ethyl acrylate or butyl acrylate.

As regards the adhesive layer (III), this comprises, as main constituent, the functional PMMA. Preferably, it is the functional PMMA obtained by the copolymerization of MMA, (meth)acrylic acid and optionally a 3rd monomer which can be copolymerized with the MMA.

The adhesive layer (III) comprises, by weight, more than 60%, advantageously more than 80%, preferably more than 90%, more preferably still more than 95% of functional PMMA. Preferably, the adhesive layer (III) does not comprise fluoropolymer to promote adhesion.

The functional PMMA makes it possible to obtain good adhesion to numerous substrates. The adhesion is strengthened from the point when the functional PMMA exhibits a content by weight of monomer carrying a functional group of greater than 0.5%, advantageously of greater than 1%, preferably of greater than 2%.

As regards the UV absorber, the latter is known per se. A list of UV absorbers will be found in the document U.S. Pat. No. 5,256,472. Use is advantageously made of benzotriazoles and benzophenones. Use may be made, by way of examples, of Tinuvin® 213 or Tinuvin® 109 and preferably of Tinuvin® 234 from Ciba Specialty Chemicals.

As regards the panel, the latter comprises at least one layer of a (ligno)cellulose material which can, for example, be:
wood;
paper, preferably kraft paper;
chipboard.

The panel can have a parallelepipedal shape. However, the invention is not limited solely to panels of parallelepipedal shape but can be applied to other shapes, for example a wedge shape. The panel finds applications, for example, in the cladding of exterior or interior facades or else to produce floors.

It can be a panel comprising a single layer, such as a panel of solid wood or a panel of chipboard. A panel of chipboard is composed of particles of wood (in various forms: sawdust, chips, fibres, and the like) treated with at least one thermosetting resin and subjected to high pressure and high temperature. A panel comprising several identical or different layers of (ligno)cellulose material(s) may also be concerned. The term “sandwich panel” is often used in this case.

The panel can also comprise at least one layer made of an elastomeric material or made of a foam, the function of which is to improve the sound insulation of the panel. It can also comprise at least one counterbalancing layer, the function of which is to mechanically stabilize the panel in order to prevent buckling or deformation of the panel.

In order to promote adhesion between the layers, an intermediate layer of an adhesive, generally a thin layer, is positioned between them. Often, the adhesive is a thermosetting adhesive, for example of the phenolic or melamine type.

### Examples of Panels

Examples of sandwich panels are given in Applications EP 1 388 414 A1, EP 1 199 157 A1 or GB 2 307 882 A. Thus, Example 1 of Application EP 1 199 157 A1 describes a panel comprising, in order:
a layer made of phenolic kraft paper with a grammage of 180/290 g/m²;
a layer of adhesive;
a layer of wood;
a decorative layer composed of a tinted cellulose film and a cellulose film impregnated with melamine and having a silica filler.

Another sandwich panel example comprises, in order, a layer of paper, a layer of wood and optionally a decorative layer or else a layer of paper and a decorative layer. Another sandwich panel example comprises, in order, optionally a decorative layer, a layer of wood, a layer of paper, a layer of wood and optionally a decorative layer. Another sandwich panel example comprises, in order, a decorative layer, a layer of wood and a decorative layer. The multilayer film is applied to the layer of wood or to the decorative layer. The layer of paper can also be replaced by a stack of several layers of paper. Preferably, the paper used is kraft paper. The decorative layer can be plain or can have a printed design. One or more film(s) of cellulose or printed paper may be concerned. A layer of thermosetting adhesive charged with pigments may also be concerned. The adhesion between the layers is provided by a layer of adhesive. Preferably, the adhesive is a thermosetting adhesive of the phenolic or melamine type.

Examples of sandwich panels which are available commercially can also be given. The panel BAQ+® from Prodema is described on the Internet site of this company as being a high density panel composed of a core made of cellulose fibres impregnated with thermosetting phenolic resins and of a natural wood layer. The panel MAD® from Prodema is described as being a panel composed of a core made of plywood impregnated with thermosetting phenolic resins and of a layer of natural wood. The panel Parklex® 1000 from Gurea is described on the Internet site of this company as being a laminated panel made of wood at high density composed internally of fibres of wood or of paper which are treated with thermoset phenolic resins and which are very strongly compressed at high temperatures and of a layer of natural wood. The multilayer film is applied against the layer of wood.

### Use of the Multilayer Film

The multilayer film of the invention is used to protect a (ligno)cellulose material, such as wood, board or paper. The adhesive layer (III) is positioned on the side of the (ligno)cellulose material. The adhesion of the film is strengthened if the latter comes into contact with a thermosetting adhesive positioned at the surface or in the body of the (ligno)cellulose material. A thermosetting adhesive is positioned between the (ligno)cellulose material and the film. The adhesive is positioned at the surface of the material in the form of a layer or else in the form of spots of adhesive at several points of the material. The (ligno)cellulose material is thus covered on all or part of its surface with the thermosetting adhesive. The adhesive can, for example, be a phenolic, for example phenol-formaldehyde, or melamine or urea-formaldehyde adhesive. The adhesive can also be present in the body of the (ligno)cellulose material, such as, for example, in the case of chipboard.

The invention also relates to a multilayer structure comprising at least one layer of a (ligno)cellulose material and the film of the invention positioned against this layer, the adhesive layer (III) being positioned on the side of the (ligno)cellulose material. More particularly, the film can be applied to a panel, one at least of the two outer faces of which is composed of a (ligno)cellulose material. The adhesive layer (III) is positioned on the side of at least one of the two outer faces made of (ligno)cellulose material. The invention also relates to such a panel.

### Advantages Provided by the Multilayer Film

The (ligno)cellulose material is protected by the multilayer film of the invention. The film provides protection against UV radiation, chemicals, scratches, atmospheric agents (dampness, salt spray, and the like), fungi and moulds, or graffiti. The film provides stability of colour and of appearance over time. The film can be applied by hot compression. Compression takes place under pressure generally of between 2 and 30 MPa and under hot conditions at a temperature generally of between 100 and 160° C.

### EXAMPLES

### Products Used

Altuglas® BS8: PMMA from Altuglas International, with an MVI of 4.5 cm³/10 min (230° C., 3.8 kg), in the form of beads, comprising, as comonomer, methyl acrylate at a level of 6% by weight. This PMMA does not comprise impact modifier.

Altuglas® PRD 510 A: the PMMA PRD 510 A is a copolymer of methyl methacrylate and ethyl acrylate (25% by weight). Its MFI is 5 g/10 minutes at 230° C. under 3.8 kg.

Altuglas® V825T: PMMA homopolymer from Altuglas International, with a melt flow of 5.5 g/10 min (230° C., 3.8 kg), in the form of granules. This PMMA is not a functional PMMA.

Altuglas® HT121: sold by Altuglas International. This product includes approximately 4.5% by weight of methacrylic acid or anhydride resulting from methacrylic acid. It exhibits a melt index of 2 g/10 min (230° C., 3.8 kg).

Tinuvin® 234: UV absorber of hydroxyphenylbenzotriazole type from Ciba Specialty Chemicals.

Kynar® 740: PVDF homopolymer from Arkema, with an MFI of 13 g/10 minutes under 12.5 kg at 230° C.

### Example 1

### According to the Invention

A three-layer film is prepared on a Kieffel extruder with, from the inside towards the outside of the bubble, the following layers:
a layer of PMMA, Altuglas® HT121, with a thickness of 10 μm,
a layer, with a thickness of 40 μm, of a blend comprising, by weight, 40.2% of Kynar® 740, 57% of a PMMA, Altuglas® PRD 510 A, and 2.8% of Tinuvin® 234, then
a layer of a blend comprising, by weight, 80% of Kynar® 740 and 20% of PMMA, Altuglas® BS8, with a thickness of 10 μm.

The film obtained is very transparent and exhibits excellent resistance to external ageing and excellent chemical resistance. This film is placed at the bottom of a mould. Two layers of kraft paper coated with coloured phenolic resin of the TPS type from Coveright are deposited on the film on the side of the PMMA, Altuglas® HT121, these layers are placed on a lamina of wood with a thickness of 200 μm precoated with phenolic resin deposited using a brush, which lamina is deposited on 30 sheets of kraft paper. After heating and reacting the phenolic resin (30 minutes at 150° C.), the object formed exists in the form of a thick board with a thickness of approximately 8 mm exhibiting an appearance of wood type.

The three-layer film exhibits excellent adhesion immediately after heating; it is not possible to peel this film from the surface of the crosslinked phenolic resin. This board is cut along its four edges in order to have board sides which are perfectly rectilinear and with dimensions of 5 cm×5 cm. This board is subsequently introduced into a bath of boiling water for 2 hours. After this treatment, neither any whitening nor any detachment is observed.

### Example 2

### Comparative

A three-layer structure is prepared on a Kieffel extruder with, from the inside towards the outside of the bubble, the following layers:
a layer of PMMA, Altuglas® V825T, with a thickness of 10 μm,
a layer with a thickness of 40 μm of a blend comprising 40.2% of Kynar® 740 from Arkema, 57% of a PMMA, Altuglas® PRD 510 A, and 2.8% of Tinuvin® 234, then
a layer of a blend of Kynar® 740 (80%) and PMMA, Altuglas® BS8 (20%), with a thickness of 10 μm.

The film obtained is very transparent and exhibits excellent resistance to external ageing and excellent chemical resistance. This film is placed at the bottom of a mould. Two layers of kraft paper coated with coloured phenolic resin of the TPS type from Coveright are deposited on the film on the side of the PMMA, Altuglas® V825 T, these layers are placed on a lamina of wood with a thickness of 200 μm precoated with phenolic resin deposited using a brush, which lamina is deposited on 30 sheets of kraft paper. After heating and reacting the phenolic resin (30 minutes at 150° C.), the object formed exists in the form of a thick board with a thickness of approximately 8 mm exhibiting an appearance of wood type. The three-layer film exhibits good adhesion immediately after heating; it is not possible to peel this film from the surface of the crosslinked phenolic resin. This board is cut along its four edges in order to have board sides which are perfectly rectilinear and with dimensions of 5 cm×5 cm. This board is subsequently introduced into a bath of boiling water for 2 hours.

After this treatment, the appearance of the board is inspected. Whitening and detachment of the edges of the film are observed.

1. A coextruded multilayer film/(ligno)cellulose composition comprising a coextruded film and a (lingo)cellulose material, said multilayer film comprising, in order, positioned one against another:
a surface layer (I) comprising, as main constituents, polyvinylidene fluoride (PVDF) and optionally polymethylmethacrylate (PMMA);
an intermediate layer (II) comprising, as main constituents, from 0 to 60 parts of a PVDF, from 40 to 100 parts of a PMMA, from 0 to 25 parts of an acrylic elastomer and from 0 to 10 parts of a UV absorber, the total forming 100 parts;
an adhesive layer (III) comprising, as main constituent, a functional PMMA, the adhesive layer (III) being positioned on the side of the multilayer film in contact with said (ligno)cellulose material.

2. The coextruded multilayer film composition of claim 1 comprising a panel comprising at least one layer of a (ligno)cellulose material, the multilayer film comprising, in order, positioned one against another:
a surface layer (I) comprising, as main constituents, a PVDF and optionally a PMMA;
an intermediate layer (II) comprising, as main constituents, from 0 to 60 parts of a PVDF, from 40 to 100 parts of a PMMA, from 0 to 25 parts of an acrylic elastomer and from 0 to 10 parts of a UV absorber, the total forming 100 parts;
an adhesive layer (III) comprising, as main constituent, a functional PMMA, and being applied to at least one of the two outer faces of the panel composed of a (ligno)cellulose material, the adhesive layer (III) being positioned on the side of at least one of the said outer faces of the panel.

3. The composition according to claim 1 wherein the film is in contact with a thermosetting adhesive at the surface or in the body of the (ligno)cellulose material.

4. The composition according to claim 1, wherein the surface layer (I) comprises, as main constituents, from 50 to 100 parts of a PVDF per respectively from 50 to 0 parts of PMMA, the total forming 100 parts.

5. The composition according to claim 1, wherein the surface layer (I) comprises, as main constituents, from 70 to 100 parts of PVDF per respectively from 30 to 0 parts of PMMA and preferably from 75 to 85 parts of PVDF per respectively 25 to 15 parts of PMMA, the total forming 100 parts.

6. The composition according to claim 1, wherein the surface layer (I) is provided in the form of two superimposed layers:
a layer (Ia) comprising, as main constituents, 75 to 100 parts of PVDF per respectively 25 to 0 parts of PMMA;
a layer (Ib), in contact with the intermediate layer (II), comprising, as main constituents, 50 to 90 parts of PVDF per respectively 50 to 10 parts of PMMA.

7. The composition according to claim 1, wherein the intermediate layer (II) comprises, as main constituents, from 0 to 60 parts of PVDF, from 40 to 100 parts of PMMA, from 0 to 25 parts of acrylic elastomer and from 0 to 10 parts of UV absorber, the total forming 100 parts.

8. The composition according to claim 7, wherein the intermediate layer (II) comprises, as main constituents, from 20 to 60 parts of PVDF, from 40 to 60 parts of PMMA, from 0 to 25 parts of acrylic elastomer and from 0 to 10 parts of UV absorber, the total forming 100 parts.

9. The composition according to claim 8, wherein the intermediate layer (II) comprises, as main constituents, from 30 to 50 parts of PVDF, from 40 to 60 parts of PMMA, from 0 to 20 parts of acrylic elastomer and from 0 to 5 parts of UV absorber, the total forming 100 parts.

10. The composition according to claim 7, wherein the intermediate layer (II) comprises from 20 to 50 parts of PVDF, from 50 to 80 parts of a PMMA comprising, by weight, from 90 to 50% of MMA per respectively from 10 to 50% of an alkyl(meth)acrylate, the alkyl having from 2 to 4 carbon atoms, and from 0 to 5 parts of a UV absorber, the total forming 100 parts.

11. The composition according to claim 7, wherein the intermediate layer (II) comprises from 25 to 45 parts of PVDF, from 55 to 75 parts of PMMA comprising, by weight, from 90 to 50% of MMA per respectively from 10 to 50% of an alkyl(meth)acrylate, the alkyl having from 2 to 4 carbon atoms, and from 0 to 5 parts of a UV absorber, the total forming 100 parts.

12. The composition according to claim 10, wherein the PMMA comprises, by weight, from 85 to 70% of MMA per respectively from 15 to 30% of an alkyl(meth)acrylate, the alkyl having from 2 to 4 carbon atoms.

13. The composition according to claim 10, wherein the PMMA comprises, by weight, from 80 to 70% of MMA per respectively from 20 to 30% of an alkyl(meth)acrylate, the alkyl having from 2 to 4 carbon atoms.

14. The composition according to claim 10, wherein the alkyl(meth)acrylate is methyl acrylate, ethyl acrylate or butyl acrylate.

15. The composition according to claim 1, wherein the adhesive layer (III) comprises, by weight, more than 60%, of a functional PMMA.

16. The composition according to claim 15, wherein the adhesive layer (III) does not comprise fluoropolymer.

17. The composition according to claim 15, wherein the functional PMMA comprises, by weight, from 0.5 to 15%, of at least one monomer carrying at least one acid, acid salt, acid chloride, epoxide, alcohol or anhydride functional group.

18. The composition according to claim 15, wherein the functional PMMA comprises, by weight:
from 65 to 99.5% of MMA,
from 0.5 to 15% of (meth)acrylic acid and/or the anhydride resulting from (meth)acrylic acid,
from 0 to 20% of a 3rd monomer which can be copolymerized with the MMA.

19. (canceled)

20. (canceled)
